(19) United States
(12) Patent Application Publication
(10) Pub. No.: US 2007/0210968 A1
(43) Pub. Date: Sep. 13, 2007

(54) SIGNAL TRANSCEIVING DEVICE AND ELECTRONIC DEVICE UTILIZING THE SAME

(75) Inventors: Cho-Ju Chung, Shenzhen (CN); Teng-Huei Chu, Shenzhen (CN); Guo-Min Zhao, Shenzhen (CN)

Correspondence Address: PCE INDUSTRY, INC.;ATT. CHENG-JU CHIANG JEFFREY T. KNAPP, 458 E. LAMBERT ROAD, FULLERTON, CA, 92835, US

(73) Assignee: HON HAI PRECISION INDUSTRY CO., LTD., Tu-Cheng (TW)

(21) Appl. No.: 11/309,582

(22) Filed: Aug. 25, 2006

(30) Foreign Application Priority Data
Mar. 7, 2006 (CN) 200610034232.4

(51) Int. Cl. H01Q 1/24

(52) U.S. Cl. 343/702; 343/841

(57) ABSTRACT

Disclosed is a signal transceiving device (30) capable of being easily mounted on a substrate (10) and providing effective transceiving performance. At least one RF module (106) is disposed on the substrate. The signal transceiving device includes at least one antenna (32) for transmitting and receiving electromagnetic wave signals, a shielding apparatus (34) and a connecting member (36). The shielding apparatus includes a shield (346) for shielding electromagnetic interference signals generated by the at least one RF module, and a base (340) for supporting the shield. The connecting member (36) is connected to the at least one antenna and the base.

### 1. FIELD OF THE INVENTION

The present invention pertains to signal transceiving devices, and particularly to an electronic device utilizing the signal transceiving device capable of being easily mounted on a substrate and providing effective transceiving performance.

### 2. DESCRIPTION OF RELATED ART

Electronic devices such as mobile telephones, personal digital assistants, and hand-held scanners having wireless communications capabilities are currently available in several different forms. As a result, various antennas for such wireless communications have been developed.

One type of commonly used antenna in the electronic device is a built-in antenna, for example, an inverted F antenna. The built-in antenna is typically used in combination with RF modules that are mounted on a substrate received in the electronic devices. Such RF modules are typically surrounded by a shield. The shield enables the RF modules to operate without electromagnetic interference caused by the antenna or other radiation source.

Conventionally, built-in antennas are designed to be detached from the shield, and thus, the shield and the build-in antennas must be manufactured separately. Consequently, cost and space requirements are increased. In addition, it is difficult to accurately mount a single built-in antenna on the substrate using SMT technology.

Therefore, a heretofore unaddressed need exists in the industry to overcome the aforementioned deficiencies and inadequacies.

### SUMMARY OF THE INVENTION

An aspect of the invention provides a signal transceiving device mounted on a substrate. At least one RF module is disposed on the substrate. The signal transceiving device includes at least one antenna for transmitting and receiving electromagnetic wave signals, a shielding apparatus and a connecting member. The shielding apparatus includes a shield for shielding electromagnetic interference signals generated by the at least one RF module, and a base for supporting the shield. The connecting member is connected to the at least one antenna and the base.

Another aspect of the invention provides an electronic device. The electronic device includes a substrate including at least one RF module disposed thereon, at least one antenna for transmitting and receiving electromagnetic wave signals, a shielding apparatus, and a connecting member. The shielding apparatus includes a shield for shielding electromagnetic interference signals generated by the at least one RF module, and a base for supporting the shield. The connecting member is connected to the at least one antenna and the base.

Other advantages and novel features will become more apparent from the following detailed description of preferred embodiments when taken in conjunction with the accompanying drawings, in which:

### BRIEF DESCRIPTION OF THE DRAWINGS

FIG. 1 is an exploded, isometric view of an electronic device of an exemplary embodiment of the present invention, the electronic device including a signal transceiving device and a substrate;

FIG. 2 is an enlarged, inverted, isometric view of a part of the signal transceiving device of FIG. 1, but not showing the substrate; and

FIG. 3 is an assembled view of FIG. 1.

### DETAILED DESCRIPTION OF THE INVENTION

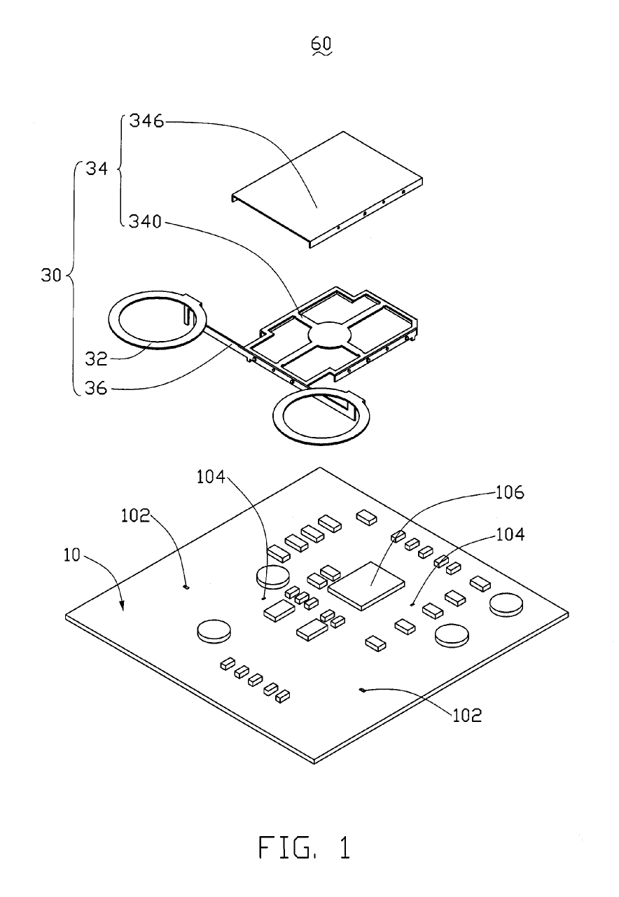

FIG. 1 shows an electronic device 60 of an exemplary embodiment of the present invention. The electronic device 60 comprises a signal transceiving device 30 and a substrate 10. The signal transceiving device 30 is mounted on the substrate 10.

The substrate 10 defines a pair of feeding holes 102 and a pair of mounting holes 104. A radio frequency (RF) module 106 is disposed on the substrate 10.

The signal transceiving device 30 comprises a pair of antennas 32 for transmitting and receiving electromagnetic wave signals, a shielding apparatus 34, and a connecting member 36. The shielding apparatus 34 comprises a base 340 and a shield 346. The connecting member 36 is connected to the antennas 32 and the shielding base 340. The shield 346 is removably mounted on the base 340 for shielding electromagnetic interference (EMI) signals generated by the RF module. The base 340 supports the shield 346 and is engaged with the shield 346. The base 340 can further prevent EMI signals from penetrating a gap between the shield 346 and the substrate 10, thus facilitating shielding of EMI signals. In this embodiment, the pair of antennas 32, the base 340, and the connecting member 36 are integrally formed as a unit.

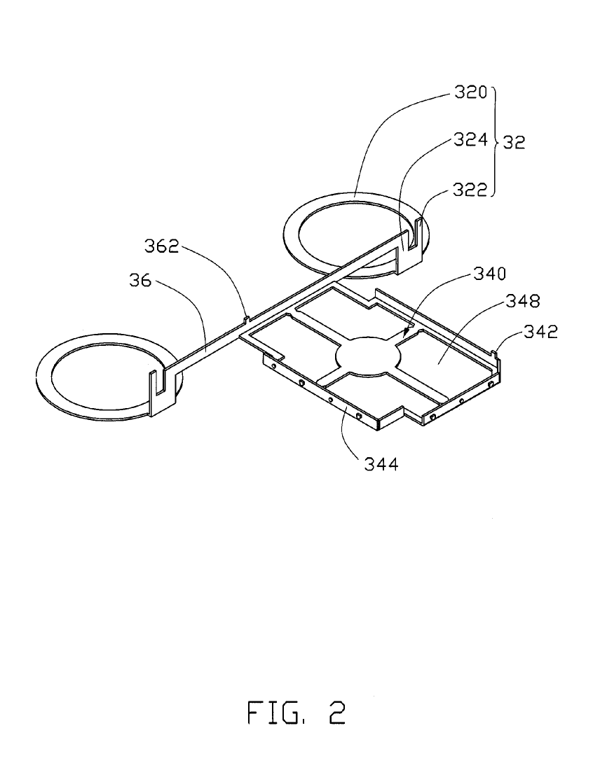

FIG. 2 shows a part of the signal transceiving device 30. The antennas 32 are inverted F antennas 32. Each of the antennas 32 comprises a radiating portion 320, a feeding pin 322, and a shorting pin 324 disposed in parallel to the feeding pin 322 with a distance therebetween. The feeding pin 322 and the shoring pin 324 are connected to the radiating portion 320. The shorting pin 324 is connected to an end of the connecting member 36. The connecting member 36 is connected to the base 340. The connecting member 36 and the base 340 act as a grounded portion for the antennas 32. A distance between the pair of antennas 32 is substantially equal to one half of a wavelength of the electromagnetic wave signals. In the exemplary embodiment, the radiating portion 320 is shaped as a ring and is parallel to the substrate 10.

The connecting member 36, shaped as a strip, comprises a protrusion 362 engaged with the corresponding mounting hole 104. The base 340 comprises a plurality of walls 344, and another protrusion 342 engaged with the corresponding mounting hole 104. The plurality of walls 344 cooperatively bounds a receiving space for receiving the RF module. The another protrusion 342 extends from one of the walls 344.

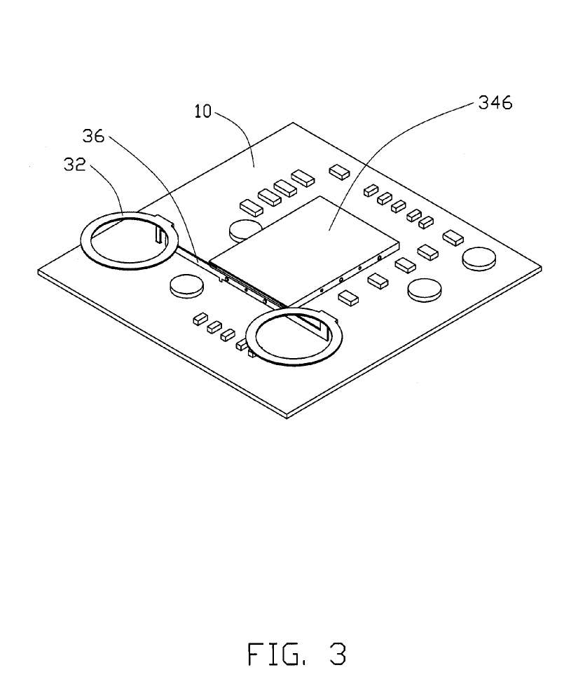

FIG. 3 shows an assembled view of the electronic device 60. In assembly, the integrated structure comprising the antennas 32, the base 340, and the connecting member 36 is mounted on the substrate 10. The protrusion 362 of the connecting member 36 and the another protrusion 342 of the base 340 are engaged with the corresponding mounting holes 104 respectively. The feeding pin 322 of each antenna 32 is received in the corresponding feeding hole 102. The RF module 106 is received in the base 340. The shield 346 is mounted on the base 340.

The combination of the antennas 32, the base 340, and the connecting member 36 into a single unit allows easy mounting on the substrate 10 through the use of the SMT technology, thus increasing the product efficiency, and reducing the space requirement making the electronic device 60 more compact.

In addition, in the exemplary embodiment, since a pair of antennas 32 are utilized in the electronic device 60, the electronic device 60 can select an antenna 32, which operates with the best transmission quality, from the antennas 32 to transmit and receive the electromagnetic wave signals. Thus, more stable and reliable wireless transmission capability is provided. In an alternative exemplary embodiment, the electromagnetic wave signals received by the antennas 32 may be combined according to a predetermined algorithm to be used for communicating.

While exemplary embodiments have been described above, it should be understood that they has been presented by way of example only and not by way of limitation. Thus the breadth and scope of the present invention should not be limited by the above-described exemplary embodiments, but should be defined only in accordance with the following claims and their equivalents.

What is claimed is:

1. A signal transceiving device, mounted on a substrate comprising at least one RF module disposed thereon, comprising:
at least one antenna for transmitting and receiving electromagnetic wave signals;
a shielding apparatus comprising a shield for shielding electromagnetic interference signals generated by the at least one RF module, and a base for supporting the shield; and
a connecting member connected to the at least one antenna and the base.

2. The signal transceiving device as claimed in claim 1, wherein the at least one antenna, the base, and the connecting member are integrally formed.

3. The signal transceiving device as claimed in claim 1, wherein the at least one antenna comprises a pair of antennas, each connected to an opposite end of the connecting member.

4. The signal transceiving device as claimed in claim 3, wherein a distance between the pair of antennas is substantially equal to one half of a wavelength of the electromagnetic wave signals.

5. The signal transceiving device as claimed in claim 1, wherein each of the antennas is an inverted F antenna comprising a radiating portion, a feeding pin, and a shorting pin, and the shorting pin is connected to the connecting member.

6. The signal transceiving device as claimed in claim 1, wherein the connecting member comprises at least one protrusion mounted on the substrate.

7. The signal transceiving device as claimed in claim 1, wherein the base comprises a plurality of walls cooperatively bounding a receiving space for receiving the at least one RF module.

8. The signal transceiving device as claimed in claim 7, wherein the base further comprises at least another protrusion extending from at least one of the walls, the at least another protrusion being mounted in the substrate.

9. An electronic device, comprising:
a substrate comprising at least one RF module disposed thereon;
at least one antenna for transmitting and receiving electromagnetic wave signals;
a shielding apparatus comprising a shield for shielding electromagnetic interference signals generated by the at least one RF module, and a base for supporting the shield; and
a connecting member connected to the at least one antenna and the base.

10. The electronic device as claimed in claim 9, wherein the at least one antenna, the base, and the connecting member are integrally formed.

11. The electronic device as claimed in claim 9, wherein the at least one antenna comprises a pair of antennas, each connected to an opposite end of the connecting member.

12. The electronic device as claimed in claim 11, wherein a distance between the pair of antennas is substantially equal to one half of a wavelength of the electromagnetic wave signals.

13. The electronic device as claimed in claim 9, wherein each of the antennas is an inverted F antenna comprising a radiating portion, a feeding pin, and a shorting pin, the shorting pin being connected to the connecting member.

14. The electronic device as claimed in claim 9, wherein the connecting member comprises at least one protrusion mounted in the substrate.

15. The electronic device as claimed in claim 9, wherein the base comprises a plurality of walls cooperatively bounding a receiving space for receiving the at least one RF module.

16. The electronic device as claimed in claim 15, wherein the base further comprises at least another protrusion extending from at least one of the walls, the at least another protrusion being mounted in the substrate.

17. An electronic device comprising:
a substrate installable in said electronic device and comprising at least one radio frequency (RF) module disposed thereon to process electromagnetic wave signals;
at least two antennas installable in said electronic device beside said substrate for transmitting and receiving said electromagnetic wave signals to be processed by said RF module, said at least two antennas spaced from each other, and each of said at least two antennas electrically communicable with said RF module via said substrate;
a shielding apparatus installable in said electronic device beside said at least one RF module, and comprising a shield to cover said at least one RF module for shielding electromagnetic interference (EMI) signals generated by said at least one RF module, and a base attachable to said substrate to support said shield for covering said RF module; and
a connecting member extending between said each of said at least two antennas and said base of said shielding apparatus so as to mechanically and electrically connect said base with said at least two antennas.

18. The electronic device as claimed in claim 17, wherein a distance between every two of said at least two antennas is substantially equal to one half of a wavelength of said electromagnetic wave signals.
